(19) United States
(12) Patent Application Publication
(10) Pub. No.: US 2015/0161628 A1
(43) Pub. Date: Jun. 11, 2015

(54) SCIENTIFIC CASTING METHOD AND APPARATUS

(71) Applicant: THOMSON LICENSING, Issy de Moulineaux (FR)

(72) Inventors: Udi WEINSBERG, Menlo Park, CA (US); Smriti Bhagat, San Francisco, CA (US)

(21) Appl. No.: 14/098,595

(22) Filed: Dec. 6, 2013

(51) Int. Cl. G06Q 30/02

(52) U.S. Cl. CPC G06Q 30/0202

(57) ABSTRACT

A method for recommending at least one element of an audio-visual program commences by first determining the success of an audio-visual program composed of a set elements initially selected by a user. Thereafter, a replacement element is substituted for at least one of the initially selected elements and the success of the audio-visual program with the replacement element is determined. Thereafter, the replacement element is recommended for substitution in place of the at least one initially selected element if substituting replacement element in the audio-visual program yields greater success.

### TECHNICAL FIELD

This invention relates to a technique for improving success of an audio-visual program, such as a movie or television program.

### BACKGROUND ART

Producers of movies and television shows (hereinafter collectively referred to as “audio-visual programs”) often spend large sums of money on the various elements that make up such audio-visual programs, including but not limited to the theme, the cast, the director, genre, location and release date. The production of an audio-visual program thus represents an investment by a producer who expects to maximize the return on that investment through distribution of the audio-visual program to various recipients. In the case of a movie, distribution typically occurs first to movie theaters. Sometime later, the movie producer will distribute the movie to one or more television networks and/or release the audio-visual program to the public via a DVD. A producer of a television shows will distribute the audio-visual program to one or more television networks first followed by DVD distribution.

Producing an audio-visual program entails careful consideration of the various elements comprising such a program. For example, the process of selecting cast members (e.g., actors) represents a very important task since casting often has a great impact on the success or failure of the audio-visual program. Presently, those involved in producing an audio-visual program view the process of selecting the various elements for that program as an art. In many instances, those individual(s) responsible for producing the audio-visual program will select a lead actor and one or more supporting actors, as well as other elements, (e.g., director, genre, theme, location and release date, for example) based on intuition, thus believing that such selections will yield a successful program because of past successes and/or popularity. In other instances, those responsible for producing the audio-visual program will undertake auditions when possible.

While selecting elements of an audio-visual program, such as cast members, requires creativity and instinct, the process generally remains ad hoc with few if any objective measurements. Thus, the producer, as well as those who make selections on behalf of the producer, have no objective way to evaluate whether different choices will increase or decrease the ultimate success of the audio-visual program.

Thus, a need exists for a technique for objectively evaluating the success of an audio-visual program based on different choices for the various elements comprising that program.

### BRIEF SUMMARY OF THE PRESENT PRINCIPLES

Briefly, a method for recommending at least one element of an audio-visual program commences by first determining the success of an audio-visual program having a set elements initially selected by a user. Thereafter, a replacement element is substituted for at least one of the initially selected elements and the success of the audio-visual program with the at least one replacement element is determined The at least one replacement element is recommended for substitution in place of the at least one initially selected element if substituting replacement element in the audio-visual program yields greater success.

### BRIEF SUMMARY OF THE DRAWINGS

FIG. 1 depicts a block schematic diagram for a system for recommending at least one replacement element for an audio-visual program for achieving greater success.

FIG. 2 depicts in flow-chart form the steps of a process for recommending at least one replacement element for an audio-visual program for achieving greater success executed by the system of FIG. 1.

### DETAILED DESCRIPTION

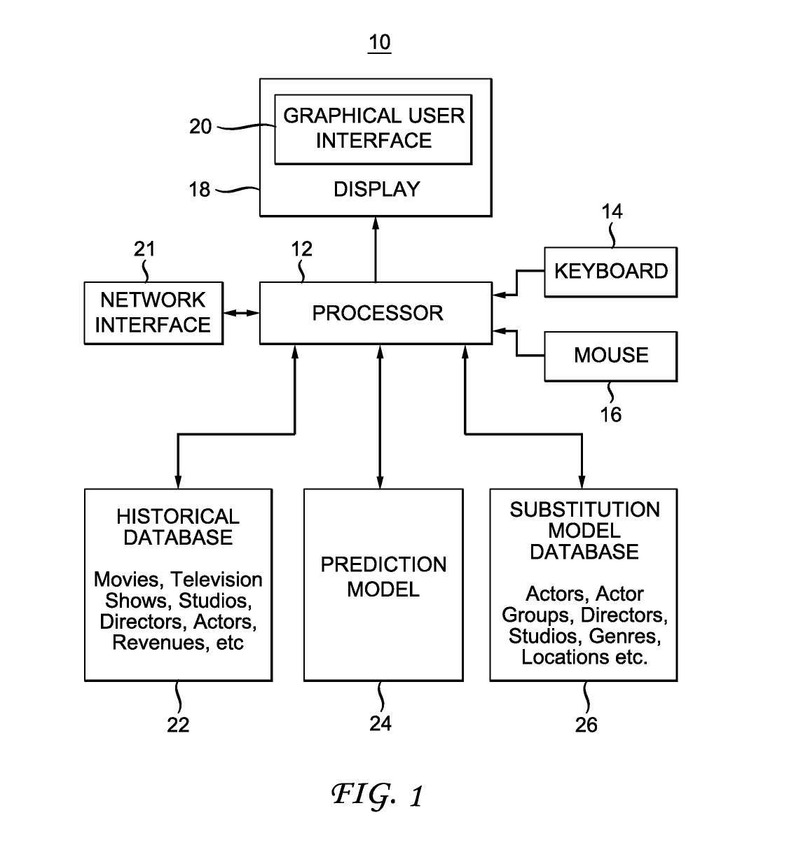

FIG. 1 depicts a system 10 for recommending at least one replacement element (for example, at least one of a theme, cast, director, genre, location and release date) for substitution in place of a corresponding initially selected element of an audio-visual program (e.g., a movie or television program) for achieving increased success. A typical audio-visual program has many different elements, including but not limited to the theme, the cast, the director, genre, location and release date, for example, that all influence the success of that program. Typically, selection of the cast (e.g., the actors) has large influence but the selection of other elements plays a role as well. Given the influence that the selection of elements has on the success of an audio-visual program, producers try to make such selections very carefully. However, heretofore, no mechanism has existed for improving element selection process by making intelligent recommendations that would increase success.

As described in detail below, the system 10 overcomes the aforementioned disadvantage by making intelligent recommendations for replacing at least one initially selected element of an audio-visual program with a replacement element to increase success. The system of FIG. 1 comprises a processor 12, typically in the form of a personal computer (e.g., a desktop or laptop computer) as well known in the art. In practice, the processor 12 receives inputs through one or more data input devices, illustratively depicted by a keyboard 14 and a mouse 16. The processor 12 can receive input data from other data entry devices (not shown), such as a touch screen display. Although not shown, the processor 12 includes memory, typically in the form on on-board RAM and ROM, and disc storage, the later storing one or more programs for making intelligent recommendations that would increase success in accordance with the present principles.

The processor 12 provides output data to at least one output device, illustratively depicted by a display device 18. In practice, the display device 18 displays a graphical user interface (GUI) 20 generated by the processor 12 to guide the user in entering data as well as to display the results generated by the processor in response to such entered data. Other devices for handling output data from the processor 12 could include a printer (not shown). In addition to providing output data to the display device 18, the processor 12 can provide such data to a network (not shown) such as the Internet, via a network interface 21, which also allows the processor to input data from the network. Additionally, the processor 12 could include a speech interface (not shown) for both receiving and interpreting input speech and providing audio output information.

The processor 12 has access to one or more databases that contain data allowing the processor to make intelligent recommendations for replacing one or more initially selected elements of an audio-visual program with replacement elements to increase success. In the illustrated embodiment of FIG. 1, the processor has access to a first database 22, which stores historical information about movies and television shows, including but not limited to, information about studios, directors, actors, audio-visual program revenues and many other audio-visual program aspects. The processor 12 also has access to at least one and possibly several substitution prediction models 24 which each predict the success of an audio-visual program using one or more criteria,. Such criteria can include star ratings, reviews from critics, audio-visual program revenues, professional awards, (e.g., Academy® awards, Emmy® awards, and Golden Globe® awards, for example.) as well as social media data, for example, with such information stored in the database 22. Thus, for example, using a substitution prediction model 24 that relies on star ratings would indicate greater success for an audio-visual program having personnel (e.g., the actors and the directors) with higher star ratings than personnel with lower ratings.

In practice, each of the substitution prediction models 24 will determine the success of the audio-visual program using a particular criterion and provide a numerical indication useful for comparison purposes as discussed hereinafter. Rather than make use of a single substitution prediction model 24, the processor 12 could make use of multiple models, each model making use of the information in the database 22 to populate the model. Thus, as an example, the processor 12 could predict the success of the audio-visual program using both star ratings and Academy® awards as a combined prediction model 24. Other combined prediction models 24 could also serve to predict the success of the audio-visual program.

In addition to the databases 22, the processor 12 also has access to a database 26, which stores substitution models to allow the processor to substitute a replacement element of for at least one of element in the set of initially selected elements for an audio-visual program. In practice, the database 26 includes information about actors, actor groups, directors, studio, genres, themes, locations, and release dates for example. Thus, to substitute a different actor for an actor initially selected for the audio-visual program, the processor 12 could access the database 26 for a list of potential replacements for substitution based on user-specified criterion (age, gender, physical stature, nationality etc.) Further, the processor 12 might suggest replacing the actor with someone having criterion different that the user-specified criterion (e.g., a younger actor) if doing so yields greater success taking into account other parameters. An important attribute of the system 10 is its ability to make decision not on a single-feature basis, but rather taking into account the interplay of the different elements that comprise the audio-visual program. The separate databases 22 and 26 could exist as single database partitioned into separate portions for serving the functions of these two databases.

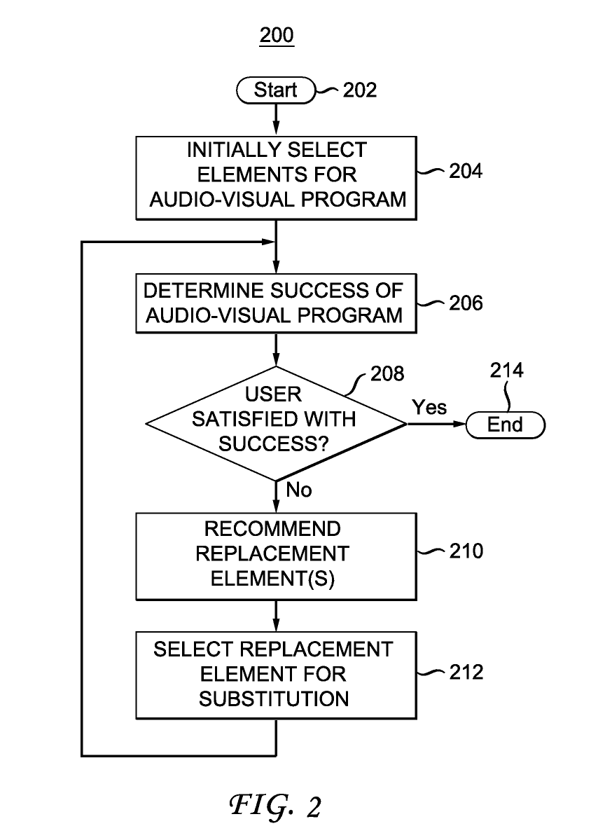

FIG. 2 depicts in flow-chart form the steps of a process 200 executed by the processor 12 of FIG. 1 for recommending a replacement element for substitution in place of at least one of initially selected element of the audio-visual program. The process 200 commences following execution of a start step 202 during which the processor 12 of FIG. 1 initializes itself. Thereafter, step 204 undergoes execution during which a user initially selects a set of elements for an audio-visual program. Thus, during step 204 the user will initially select the theme, the cast, the director, genre, location and release date, as well as other elements associated with the audio-visual program. In selecting the various elements for the audio-visual program, the user can instruct the processor 12 to access one or both of the databases 22 and 26 of FIG. 1. Next, the processor 12 executes step 206 to determine the success of the audio-visual program with the user's initially selected elements using at least one more substitution prediction model 24. Thereafter, during step 208, the user will indicate to the processor 12 whether the user is satisfied with the success of the audio-visual program with its initially selected elements. Assuming that the user has indicated his or her dissatisfaction of the success to the processor 12 following step 208, then the processor executes step 210 to recommend one or more replacements for substitution in place of elements initially selected during step 204. For example, during step 210, the processor 12 will recommend one or more replacements for a particular element, say a lead actor. Alternatively, the processor 12 could recommend replacements for a variety of elements (e.g., director, genre, theme, location and release date), depending on user preference. In recommending a replacement for the initially selected lead actor, the processor 12 could suggest those actors having similar attributes (e.g., age, physical attributes, nationality etc.) or actors who co-starred in other audio-visual programs with the initially selected actor. Alternatively, the processor 12 could recommend a one or more lead actors having different attributes, but higher star ratings, or a greater number of awards. The processor 12 would apply other strategies for recommending replacements for other elements. For example, if the audio-visual program has a comedic theme, then the processor 12 could recommend one or more replacement directors for the initially selected direct from a list of directors who had previously directed successful comedies.

Following step 210, the processor 12 will present the recommended replacement(s) to the user who will select a replacement recommended by the processor 12 for each element considered by the processor (e.g., either a single element such as lead actor, or multiple elements (e.g., lead actor, director, genre, theme, location and release date). Thereafter, program execution branches back to step 206 during which the processor 12 of FIG. determines the success of the audio-visual program with the replacement element(s) selected by the user during step 212. Thereafter, the user will indicate his or her satisfaction with the success of the audio-visual program determined during re-execution of step 208. The processor 12 will iteratively execute steps 210, 212, and 206 until the user indicates his or her satisfaction with the success following step 208, whereupon the process ends during step 214.

The process 200, as described above, provides a much more objective approach to recommending replacements for the various elements that comprise an audio-visual program. In particular, the process 200 can apply much greater intelligence to the process of casting actors for an audio-visual program by using an objective measurement to compare different actors. As discussed above, each of the various substitution prediction models 24 of FIG. 1 provides an objective measure of success of audio-visual program using at least one criterion. By evaluating a particular element of the audio-visual program, such as a cast member, using one or more of the substitution prediction models 24, the system 10 can objectively measure the success of the audio-visual program by substituting different elements, and particularly, different cast members.

Using the process 200 of FIG. 2, the user can test the success of various different replacement elements recommended by the processor 12. For example, during step 212, the user can request that the system 10 to suggest various replacement lead actors as a single category rather than suggest replacements for a variety of elements. During step 212, the user can select one of the replacement lead actors recommended by the processor 12 during step 210 and then test the success of that choice during re-execution of step 206. If dissatisfied by that choice (as indicated by either a drop in the success or at best, an insignificant increase), the user can then repeat the process and pick another recommended lead actor until the user becomes satisfied by success associated with that choice.

The foregoing describes a technique for improving success of an audio-visual program, such as a movie or television program.

1. A method for recommending at least one element of an audio-visual program, comprising the steps of:
determining success of the audio-visual program composed of a set of initially selected elements;
substituting at least one initially selected element of the audio visual program with a replacement element from a database and determining success of the audio visual program with the replacement element; and
recommending substitution of the replacement element in the audio-visual program if substituting the replacement element in the audio-visual program yields greater success.

2. The method according to claim 1 wherein the steps of substituting at least one element of the audio visual program with a replacement element and determining success of the audio visual program with the replacement element are repeated for different types of element.

3. The method according to claim 1 wherein the audio-visual program comprises one of a movie or television show.

4. The method according to claim 1 wherein the at least one element comprises one of a theme, a cast member, a director, theme, genre, location, and release date.

5. The method according to claim 1 wherein the success of the audio-visual program is determined using at least one substitution prediction model.

6. The method according to claim 5 wherein the at least one substitution prediction model determine success of the audio-visual product in accordance with at least one of: star ratings, reviews from critics, audio-visual program revenues, professional awards and social media data.

7. A system for method for recommending at least one element of an audio-visual program, comprising
a processor, responsive to user input of a set of elements initially selected for an audio-visual program for (1) determining the success of that program with the initially selected elements; (2) substituting at least one element of the audio visual program with a replacement element and determining success of the audio visual program with the replacement element; and (3) recommending substitution of the replacement element in the audio-visual program if substituting the replacement element in the audio-visual program yields greater success.

8. The system according to claim 7 wherein the processor substitutes replacements for different types of elements.

9. The system according to claim wherein 7 the audio-visual program comprises one of a movie or television show.

10. The system to claim 7 wherein the at least one element comprises one of a theme, a cast member, a director, theme, genre, location and release date.

11. The system according to claim 7 wherein the processor determines the success of the audio-visual program using at least one substitution prediction model.

12. The system according to 7 wherein the at least one substitution prediction model relies on at least one of: star ratings, reviews from critics, audio-visual program revenues, professional awards and social media data.

13. A method for evaluating success of an audio-visual program, comprising the step of:
applying a prediction model that relies on at least one of: star ratings, reviews from critics, audio-visual program revenues, professional awards and social media data.
